(19) United States
(12) Patent Application Publication
(10) Pub. No.: US 2016/0147294 A1
(43) Pub. Date: May 26, 2016

(54) Apparatus and Method for Recognizing Motion in Spatial Interaction

(71) Applicant: Samsung Electronics Co., Ltd., Suwon-si (KR)

(72) Inventors: Su-jung BAE, Yongin-si (KR); Moon-sik JEONG, Seongnam-si (KR); Sung-do CHOI, Suwon-si (KR)

(21) Appl. No.: 14/952,897

(22) Filed: Nov. 25, 2015

(30) Foreign Application Priority Data
Nov. 26, 2014 (KR) 10-2014-0166624

(51) Int. Cl. G06F 3/01

(52) U.S. Cl. CPC G06F 3/011

(57) ABSTRACT

Disclosed is a method of recognizing, by a terminal, a motion of a user. The method includes receiving, by a terminal, a plurality of motion inputs, determining an intended motion input from among the plurality of motion inputs received, and performing terminal control corresponding to the intended motion input determined from among the plurality of motion inputs received. Determining the intended motion input includes determining, as the intended motion input, a motion input which is input for a first time after a motion input which is in a stationary state for at least a predetermined time is received.

### RELATED APPLICATION(S)

This application claims the benefit of Korean Patent Application No. 10-2014-0166624, filed on Nov. 26, 2014, in the Korean Intellectual Property Office, the disclosure of which is incorporated herein in its entirety by reference.

### BACKGROUND

The present disclosure relates to a method of recognizing a motion intended by a user in spatial interactions and a digital device for performing the same.

A remote controller is provided for most devices so as to easily control digital devices such as set-top boxes, digital televisions (TVs), etc. Also, as functions of digital devices are diversified, an attempt to variously modify control means such as remote controllers and the like is being made for more effectively controlling and using the functions of the digital devices and enhancing convenience of users.

For example, a gyro sensor may be built in a remote controller, and thus, a user input may be transferred via movement of the remote controller instead of a simple key input. Also, a motion recognition sensor such as a gyro sensor and/or the like is built in a game system, and thus, various types of games may be played at home. Also, technology is being proposed in which an air mouse is used to control a personal computer (PC), and an operation of the PC is controlled by a user input that is transferred by recognizing a motion of moving, by the user, the air mouse in the air.

However, it is inconvenient for a user to move while gripping a remote controller or the like. Therefore, technology is being researched and developed for controlling a device through a motion of a user's body, not through the movement of the remote controller which needs to be gripped by the user.

A motion of a user's body may be detected by using various sensors built in a device and may function as device control information. Information about a motion of a user's body may be pre-stored in the device. When a motion of a user's body corresponding to the pre-stored information is detected, the detected motion may be determined as device control information.

However, a motion of a user is performed in a space. If the user's every motion is determined as device control information, even user's unintended motions also may function as the device control information. If user's unintended movement functions as the device control information, the device may fail to work according to user's intention.

### SUMMARY

Provided are a method of recognizing a motion in a digital device and an apparatus for performing the same.

Provided are a method and apparatus for determining a motion intended by a user among motions of the user.

Additional aspects will be set forth in part in the description which follows and, in part, will be apparent from the description, or may be learned by practice of the presented exemplary embodiments.

According to an aspect of an exemplary embodiment, a method of recognizing a motion of a user includes: receiving, by a terminal, a plurality of motion inputs; determining an intended motion input from among the plurality of motion inputs received; and performing terminal control corresponding to the intended motion input determined from among the plurality of motion inputs received, wherein determining an intended motion input comprises determining, as the intended motion input, a motion input which is input for a first time after a motion input which is in a stationary state for at least a predetermined time is received.

The method may further include storing the intended motion input determined in a storage of the terminal.

The storage may store terminal control information corresponding to the intended motion input.

The plurality of motion inputs may be received via a movement of predetermined subject shape among subject shapes which are input through an input unit of the terminal.

The predetermined subject shape may include at least one of shapes of a head, a hand, an arm, a foot, and a leg of the user.

The plurality of motion inputs received may include the intended motion input determined and a reverse motion which is moved opposite to the intended motion input determined.

The plurality of motion inputs received may include at least one of a swipe motion input, a pinch-to-zoom motion input, and a rotation motion input.

Receiving a plurality of motion inputs may include: detecting a subject in successive images received by the terminal; distinguishing a region of the detected subject from other regions via image segmentation; and extracting a subject shape in the region of the subject distinguished.

The method may further include storing the subject shape in a storage of the terminal.

The plurality of motion inputs may be received by an input unit of the terminal, and the input unit may include at least one of an optical sensor, an infrared sensor, an electromagnetic sensor, an ultrasonic sensor, and a gyro sensor.

According to an aspect of another exemplary embodiment, a terminal for recognizing a motion of a user includes: an input unit configured to receive a plurality of motion inputs; and a controller configured to determine an intended motion input from among the plurality of motion inputs received and perform terminal control corresponding to the intended motion input determined from among the plurality of motion inputs received, wherein the controller determines, as the intended motion input, a motion input which is input for a first time after a motion input which is in a stationary state for at least a predetermined time is received.

According to an aspect of another exemplary embodiment, a device for recognizing a motion may be a non-transitory computer-readable storage medium storing a program for executing the methods in a computer.

According to an aspect of another exemplary embodiment, provided is one or more non-transitory computer-readable storage media comprising instructions that are operable when executed to: receiving, by a terminal, a plurality of motion inputs; determining an intended motion input from among the plurality of motion inputs received; and performing terminal control corresponding to the intended motion input determined from among the plurality of motion inputs received, wherein determining an intended motion input comprises determining, as the intended motion input, a motion input which is input for a first time after a motion input which is in a stationary state for at least a predetermined time is received.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram illustrating a method of recognizing a motion of a user, according to an exemplary embodiment;

FIG. 2 is a diagram illustrating a method of recognizing a motion of a user over time, according to an exemplary embodiment;

FIG. 3 is a diagram illustrating a method of recognizing a movement of a user's body, according to an exemplary embodiment;

FIGS. 4A, 4B, 4C, and 4D are diagrams illustrating parts of a user's body, which are targets of motion recognition, according to an exemplary embodiment;

FIG. 5 is a flowchart illustrating a step of recognizing a motion, according to an exemplary embodiment;

FIG. 6 is a flowchart illustrating a step of detecting a hand region of a user, according to an exemplary embodiment;

FIG. 7 is a flowchart illustrating a step of detecting a hand region of a user, according to another exemplary embodiment;

FIG. 8 is a diagram illustrating a method of recognizing a swipe motion input, according to an exemplary embodiment;

FIGS. 9 and 10 are diagrams illustrating a method of recognizing a pinch-to-zoom motion input, according to an exemplary embodiment;

FIGS. 11 and 12 are diagrams illustrating a method of recognizing a rotation motion input, according to an exemplary embodiment;

FIG. 13 is a diagram illustrating a method of recognizing a motion made using a body of a user, according to an exemplary embodiment;

FIG. 14 is a block diagram conceptually illustrating a structure of a digital device according to an exemplary embodiment; and

FIG. 15 is a block diagram conceptually illustrating a structure of a digital device according to another exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of at least one selected from the group including the associated listed items. Expressions such as “at least one of,” when preceding a list of elements, modify the entire list of elements and do not modify the individual elements of the list.

Hereinafter, exemplary embodiments will be described in detail with reference to the accompanying drawings. In the drawings, like reference numerals refer to like elements, and the size and thickness of each element may be exaggerated for clarity and convenience of description.

For example, examples of the touch input described herein may include a drag, a flick, a tap, a double tap, a swipe, a touch and hold, a drag and drop, a pinch-to-zoom, etc.

The drag denotes a motion where a user touches a screen with a finger or a touch tool (e.g., an electronic pen, or a stylus) and then moves the finger or the touch tool to another position of the screen while maintaining the touch.

The tap denotes a motion where a user touches a screen with a finger or a touch tool and then immediately lifts the finger or the touch tool without any movement.

The double tap denotes a motion where a user touches a screen twice with a finger or a touch tool.

The flick denotes a motion where a user touches a screen with a finger or a touch tool and then drags the finger or the touch tool at a threshold speed or faster. The drag and the flick may be distinguished based on whether a movement speed of a finger or a touch tool is equal to or higher than the threshold speed, but the present specification, the flick may be construed as being included in the drag.

The swipe denotes a motion where a user touches a region of a screen with a finger or a touch tool and moves the finger or the touch tool in a horizontal or vertical direction. A diagonal-direction movement may not be recognized as a swipe event, or may be recognized one of either a horizontal or a vertical swipe event based on a vector component of the diagonal-direction movement. In the present specification, the swipe may be construed as being included in the drag.

The touch and hold denotes a motion where a user touches a screen with a finger or a touch tool and maintains a touch input for a threshold time or longer. That is, the touch and hold denotes a case where a time difference between a touch timing and a touch-releasing timing is equal to or longer than the threshold time. The touch and hold may be called a long press. In order to notice the user whether a touch input is determined as the tap or the touch and hold, when the touch input is maintained for the threshold time or more, a feedback may be visually or acoustically provided to users.

The drag and drop denotes a motion where a user drags a graphic object to a position with a finger or a touch tool in an application and then lifts the finger or the touch tool from the position.

The pinch-to-zoom denotes a motion where a user progressively increases or decreases a distance between two or more fingers or touch tools. When the distance between fingers increases, the pinch-to-zoom may be used as a zoom in input. When a distance between fingers decreases, the pinch-to-zoom may be used as a zoom out input.

In the present specification, the motion input denotes an input which is applied to a device by a motion of a user for controlling the device. For example, the motion input may include an input by rotating the device, an input by tilting the device, and an input moving the device in up, down, left, and right directions. The device may sense, by using an acceleration sensor, a tilt sensor, a gyro sensor, a 3-axis magnetic sensor, an ultrasonic sensor, and/or the like, the motion input based on motions preset by the user.

In the present specification, the bending input denotes an input which is applied to a device by bending the device for controlling the device which is a flexible device. According to an exemplary embodiment, the device may sense a bending position (a coordinate value), a bending direction, a bending angle, a bending speed, the number of times the device is bent, a timing when a bending operation starts, a time for which the bending operation is maintained, and/or the like by using a bending sensor.

In the present specification, the key input denotes an input which is applied to a device by a physical key of the device for controlling the device.

In the present specification, the multimodal input denotes an input which is applied to a device by at least two or more inputs of which modes are combined. For example, a device may receive a touch input and a motion input together. The device may also receive a touch input and a voice input. The device may also receive a touch input and an eye tracking input. The eye tracking input denotes an input which is applied to a device by eye-blinking, a viewing position, a speed of eye-gaze pointing, and/or the like for controlling the device.

According to some exemplary embodiments, a device may include a transceiver that receives an application execution command from an external device connected to the device.

The external device may include a portable terminal, a smartphone, a notebook computer, a laptop computer, a tablet personal computer (PC), an e-book terminal, a digital broadcasting terminal, a personal digital assistant (PDA), a portable multimedia player (PMP), a navigation device, or an MP3 player, but is not limited thereto.

For example, a user may request execution of an application installed in the device through a portable terminal, a smartphone, a notebook computer, a table PC, or a navigation connected to the device. The external device may transmit an application execution command to the device through short-distance communication such as Bluetooth, near field communication (NFC), or, Wi-Fi Direct (WFD). Also, in this disclosure below, the term “device” may be called a terminal.

According to an exemplary embodiment, the device may execute an application in response to a user input. The user input may be an input that requests execution of the application. Also, the device may receive an execution command from the external device connected to the device and execute the application of the device.

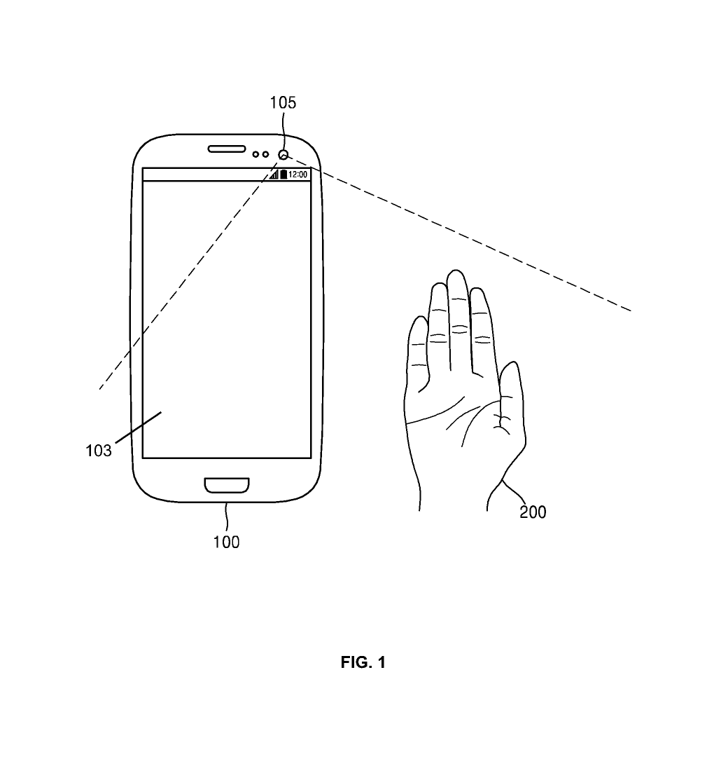

FIG. 1 is a diagram illustrating a method of recognizing a motion of a user, according to an exemplary embodiment.

A user may use various methods for inputting a device control command to a device. The user may input the device control command corresponding to an intention of the user by pressing a key button built in the device or by touching a touch screen built in the device. Alternatively, the user may input the device control command by a voice of the user, in addition to a physical touch, and moreover, a control command signal may be transmitted by using a remote controller, an external device, or the like.

A user may input a device control command to a device through a motion input. In this case, the motion input of the user may be input by two ways. Firstly, by moving the device itself, motion information may be obtained through an acceleration sensor, a tilt sensor, a 3-axis magnetic sensor, or a gyro sensor included in the device and may function as the device control command for the device.

Secondly, by recognizing a movement of the user's body, motion information may be obtained and the motion information may function as the device control command for the device when the obtained motion information corresponding to the recognized motion is matched with pre-stored motion information. In this case, an input unit of the device may recognize a movement (or a motion) of the user to detect a motion input from successive images obtained through an optical sensor such as a camera. The input unit of the device may sense through an illuminance sensor a change in peripheral illuminance of the device to detect the motion input. Furthermore, a motion input of a user may be recognized by using an infrared sensor, a thermal sensor, and/or the like.

As illustrated in FIG. 1, a front camera 105 built in a device 100 may recognize a motion of a user. The device 100 may detect a movement in successive images or video about the motion of the user photographed in line-of-sight (LOS) of the front camera 105, and may determine the detected movement as a control command for the device 100.

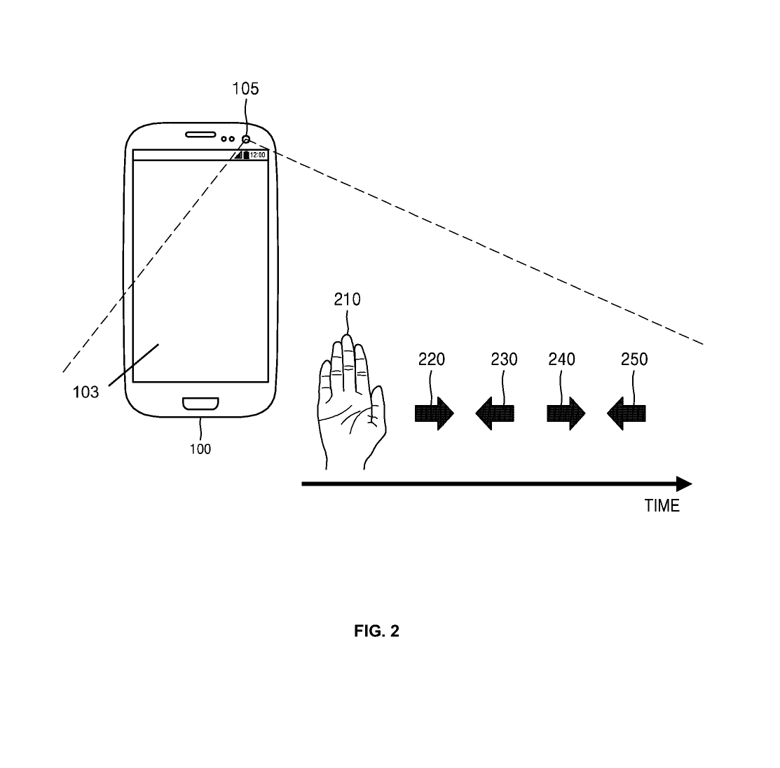

FIG. 2 is a diagram illustrating a method of recognizing a motion of a user over time, according to an exemplary embodiment.

As illustrated in FIG. 2, the user may make a motion in front of the device 100, for inputting a control command to the device 100. Here, the range may be limited to a range (i.e., the photographing range of the front camera 105) for an input unit of the device 100 enough to recognize the motion.

The user may make various motions for controlling the device 100 over time. In FIG. 2, a motion of the user is described by five time sections 210 to 250. The five time sections 210 to 250 are not limited to the same time duration, and one of time sections may be longer or shorter than the others.

The user may move a part of the user's body, such as, for example, a hand, over the front camera 105 of the device 100. For example, in order to scroll a screen, switch between screens displayed by the device 100, or switch between apps launched by the device 100, the user may move the hand in a left-and-right direction for inputting a swipe motion input.

Referring to FIG. 2, when the hand is located over the front camera 105 in the time section 210, and in the time section 220, the user may move the hand from the left to the right (hereinafter referred to as a left-right swipe motion, for convenience of description). A screen 103 displayed in the device 100 may be scrolled to the left or switched to its previous screen according to the left-right swipe motion. However, the left-right swipe motion may function as another control command, such as, scrolling right or switching to its next screen, and may function as a control command predetermined for the left-right swipe motion.

The user may repeat the left-right swipe motion for scrolling or switching the screen once again.

After the left-right swipe motion is made, in order for the user to repeat the left-right swipe motion, the user may move his or her hand from the right to the left first. Therefore, referring to FIG. 2, the user may move the hand from the right to the left in the time section 230 first, and then make the left-right swipe motion in the time section 240. Subsequently, in the time section 250, the user may move the hand from the right to the left again for moving the hand to an original position.

The motions of the user for intentionally controlling (switching) the screen of the device 100 in FIG. 2 are two left-right swipe motions in the time sections 220 and 240 among all of the time sections 210 to 250. However, the device 100 may determine motions in the time sections 230 and 250 for repeating the left-right swipe motions, as right-left swipe motions. Therefore, the device 100 may receive all of the motions in all of the time sections 210 to 250 and determine the all of the motions as control information of the device 100.

That is, even when the user makes motions with intention of two left-right swipe input, but the device 100 may receive a left-right swipe input in the time section 220, a right-left swipe input in the time section 230, a left-right swipe input in the time section 240, and a right-left swipe input in the time section 250 in such a way the device 100 may switch a screen to its previous screen in response to the left-right swipe input in the time section 220, and then the screen displayed in the time section 210 may be switched back again in response to the right-left swipe input in the time section 230, which may produce an unintended result.

In order to reduce possibility of unintended inputs by motions of a user, the following method may be employed.

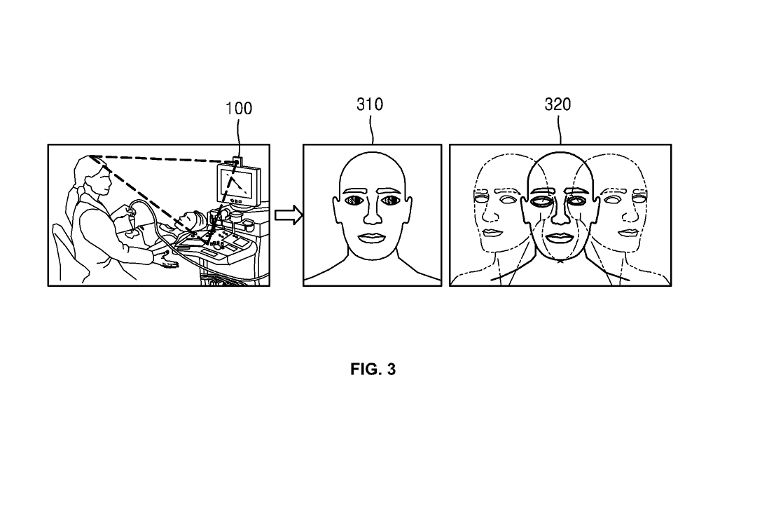

FIG. 3 is a diagram illustrating a method of recognizing a motion of a user's body, according to an exemplary embodiment.

As illustrated in FIG. 3, a user of the device 100 may input a control command to the device 100 by laterally moving his or her head 310. The input unit of the device 100 may detect the movement of the head 310 of the user, and use the detected movement as motion input information.

A range of head motion is limited. The user may return his or her head back to an original position so as to look at the front of the device 100.

After the user makes a motion input by turning the head 310 to the left or to the right from original position, the user may look at the front of the device 100 by turning the head 310 back to the original position. In such a way the device 100 may recognize all of the movements, and then determine all of the recognized movements to be matched with an intention of the user, which may result in a problem that the device 100 performs control operations respectively corresponding to all of the recognized motions. Therefore, a predetermined condition for determining, by the device 100, an intended motion input which is matched with an intention of the user may be employed.

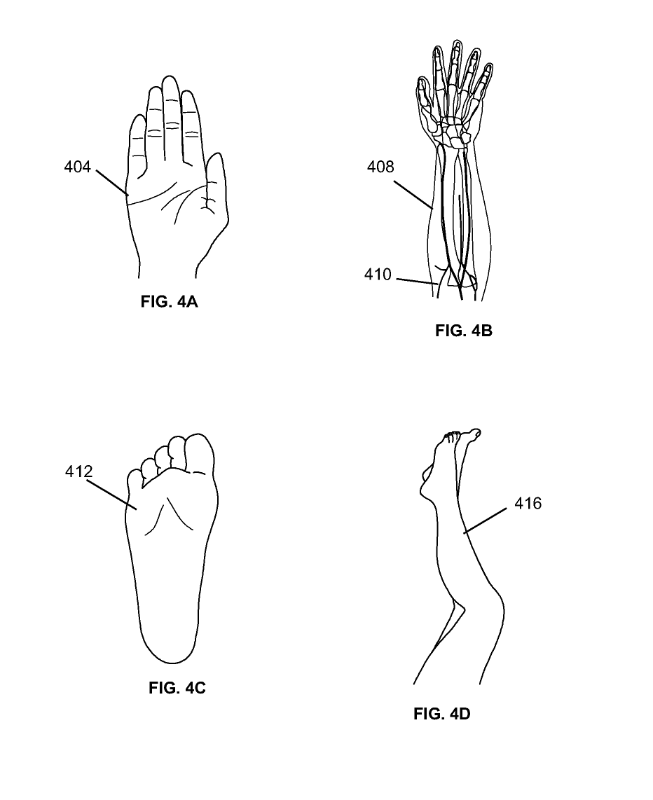

FIGS. 4A, 4B, 4C, and 4D are diagrams illustrating parts of a user's body whose a motion is to be recognized, according to an exemplary embodiment.

As illustrated in FIGS. 4A, 4B, 4C, and 4D, any body part capable of being moved based on an intention of a user may be used to perform a motion input. Since the user has a voluntary muscle which is included in a part of his or her body, the user may move his or her body part capable of being moved based on his or her intention, thereby a control command for controlling a device may be generated.

As illustrated in FIG. 4A, the user may move his or her hand 404 to perform the motion input. Although not shown, the user may move a finger or close and open the hand 404 to perform the motion input. As illustrated in FIG. 4B, the user may move a whole arm 408, or bend and straighten an elbow 410 to perform the motion input.

As illustrated in FIGS. 4C and 4D, the user may move a foot 412 and a leg 416 to perform a motion input for the device, respectively. Since movements of a foot and a leg are similar to those of the hand 404 and the arm 408, descriptions of the hand 404 and the arm 408 may be applied to a foot and a leg.

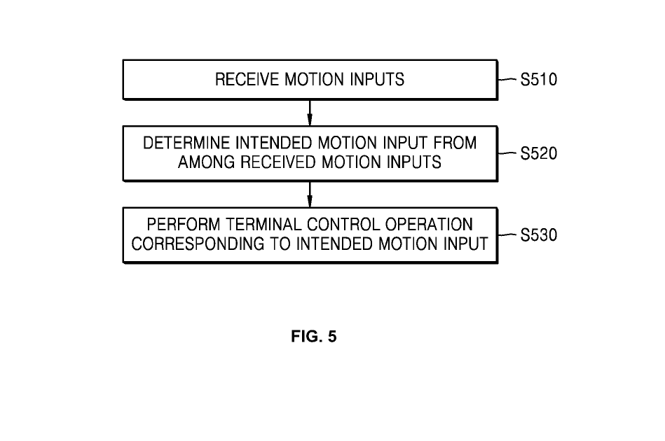

FIG. 5 is a flowchart illustrating a process of recognizing a motion, according to an exemplary embodiment.

In order to reduce possibility of unintended inputs by motions of a user, a predetermined condition for determining, by the device 100, an intended motion input which is matched with an intention of the user may be employed is described hereinafter.

In operation S510, the device may receive a motion input of the user through an input unit of the device 100. The input unit of the device 100 may be included or embedded in the device 100, connected to the device 100 via wire or wirelessly, or connected to the device 100 through one or more networks (not shown). When the motion input of the user is a one-time input, it is less likely that the motion input is determined as an unintended input. However, when a plurality of motion inputs are repeated, the device 100 may not distinguish an intended motion input, matched with an intention of the user, from a reverse motion input which is made in an opposite direction of the intended motion input, causing an unintended input. A case that the device 100 receives a plurality of motion inputs is mainly described in the present disclosure.

The input unit of the device 100 may receive a motion input by a movement of the user. The input unit of the device 100 may detect a motion input in successive images obtained through an optical sensor such as a camera, or may sense through an illuminance sensor a change in peripheral illuminance of the device 100 to detect the motion input. Furthermore, the motion input of the user may be recognized by using an infrared sensor, a thermal sensor, and/or the like. A method of detecting, by the device 100, the motion input in an obtained image will be described below.

In operation S520, the device may determine an intended motion input, matched with an intention of the user, from among a plurality of motion inputs received through the input unit. The user may define a standard to determine an intended motion input among a plurality of motion inputs, and the defined standard may be used intended motion input as preference to the device 100.

In this disclosure, the device 100 may determine a motion input, which is received for a first time, as an intended motion input matched with an intention of the user after receiving a stationary motion input for or more than a predetermined time. a preliminary motion input for an intended motion input also may be employed, thereby, a motion input received for the first time after receiving the preliminary motion input may be determined as the intended motion input matched with an intention of the user For example, the preliminary motion input may be input to the device by a motion of applauding or by closing and opening the hand 404 once over a camera of the device, but which is less effective than employing the stationary motion for or more than the predetermined time intended motion input. By maintaining the stationary state for or more than a predetermined time before making the intended motion input of the user, the device may determine intended motion input, as the intended motion input, a motion input which is received for the first time after the stationary state. A motion input in the stationary state may include a motion input moving within a predetermined range.

If the user moves the hand 404 from down to up over a front camera 105 of the device 100(such as, for example, a smartphone) for scrolling the screen 103 while reading news articles displayed in the screen 103 of a display of the smartphone. When the user maintains his or her hand 404 in a stationary state for or more than a predetermined time and then moves the hand 404 in the upper direction, a controller (not shown) of the smartphone may determine the upward movement of the hand 404 as an intended motion input (hereinafter referred to as a down-up scroll input, for convenience of description). On the other hand, when the user maintains the hand 404 in a stationary state for or more than a predetermined time and then moves the hand 404 downward, a controller of the smartphone may determine the downward movement as an intended motion input (hereinafter referred to as an up-down scroll input, for convenience of description).

After the down-up scroll input or the up-down scroll input, a motion input by a direction opposite thereto may be input to the device unintentionally.

Since the down-up scroll input is received after the stationary state is maintained for or more than the predetermined time, the smartphone may determine intended motion input the down-up scroll input as an intended motion input of the user. Therefore, even when the up-down scroll input is received by an unintended movement of the user after the down-up scroll input, the smartphone may not determine the received up-down scroll input as an intended motion input.

In operation S530, the device may perform a device control operation corresponding to the intended motion input determined from among the received plurality of motions. Since the device distinguishes the intended motion input of the user from an unintended motion input in operation S520 described above, the device may determine, as the intended motion input of the user and may not perform a device control operation corresponding to the unintended motion input.

The device may store the determined intended motion input in a storage of the device. The storage may be included in the device, connected to the device by wire or wirelessly, or connected to the device through networks. The storage may store a database of various motions set by the user. As shown in Table I, various motions may be stored in the storage according to an exemplary embodiment.

TABLE I

| Motion | Application | Control command |
|---|---|---|
| Left-right swipe | Image viewer | Call left screen |
| | | (Call previous screen) |
| | Music player | Turn up the volume |
| | Video player | Play forward |
| Right-left swipe | Image viewer | Call right screen |
| | | (Call next screen) |
| | Music player | Turn down the volume |
| | Video player | Rewind |
| Zoom-in pinch-to-zoom | Image viewer | Zoom-in screen |
| | Desktop | Separate objects |
| | | displayed on |
| | | screen |
| Zoom-out pinch-to-zoom | Image viewer | Zoom-out screen |
| | Desktop | Group objects |
| | | displayed on |
| | | screen |
| Clockwise rotation | Image viewer | Rotate screen |
| | | clockwise |
| | Music player | Turn up the volume |
| | Video player | Play forward |
| Counterclockwise | Image viewer | Rotate screen |
| rotation | | counterclockwise |
| | Music player | Turn down the volume |
| | Video player | Play reward |
| Tap | Desktop | Select object |
| | Music player | Play/Stop |
| Double tap | Desktop | Execute application |
| | Video player | Play/Stop |
| Up-down scroll | Image viewer | Call upper screen |
| | | (Call previous screen) |
| | Music player | Turn down the volume |
| Down-up scroll | Image viewer | Call lower screen |
| | | (Call next screen) |
| | Music player | Turn up the volume |
| Close and open hand | Image viewer | Zoom-in screen |
| | File management | Paste data stored |
| | program | in buffer |
| Open and close hand | Image viewer | Zoom-out screen |
| | File management | Store data in buffer |
| | program | |

In addition to the motions shown in Table I, various motions recognized by the input unit of the device in a three-dimensional (3D) space may be employed for a control command for the device. The user may define the control command for the device in a different way of Table I.

Different motion inputs may be used for the same control command of the device. For example, a left-right swipe motion input and a clockwise rotation motion input may be used for turning up the volume of the device as shown in Table I according to a system setting or user preference.

A control command, corresponding to a motion input of a user, for the device may be differently defined based on applications. A control command which is input by the user may be differently set based on applications. For example, an up-down scroll motion and a down-up scroll motion input may be used for moving a screen upward and downward in an Internet browser application, and may be used for turning down or up the volume, in a video play application.

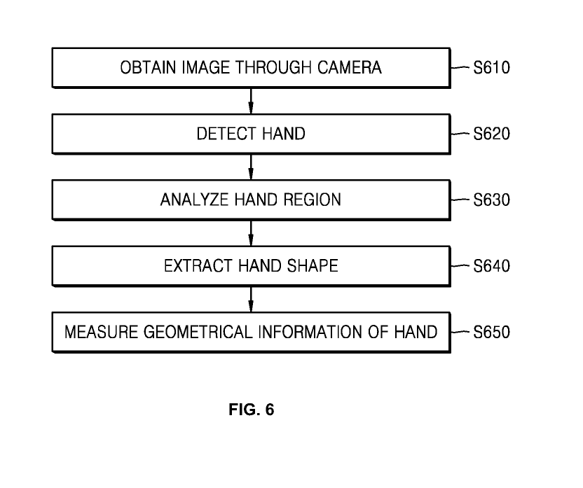

FIG. 6 is a flowchart illustrating a step of detecting a hand region of a user, according to an exemplary embodiment.

Referring to FIG. 6, a step of extracting a motion input in successive images captured by the camera is described hereinafter.

In operation S610, the device may obtain successive images through the camera corresponding to the input unit of the device, for obtaining a movement of the user. Video may also be included in the successive images. The controller of the device may determine a region, where a pixel value such as a red-green-blue (RGB) value changes more than a predetermined threshold or other regions, in the obtained images so that the region where a motion of the user is made may be determined. For example, when the obtained successive images include the user waving his hand 404 404, a region where the user's hand 404 moves have pixels whose pixel values changes more than other regions in the obtained successive images. The parameters for pixels may include other values, such as a gray value, brightness, but not limited thereto.

In operation S620, the controller of the device may detect a hand region in the obtained images. The controller of the device may determine whether shapes of the same or similar subjects are included in the obtained images, based on information about shapes of various subjects pre-stored in the storage. For example, information about a hand shape of the user may be stored in the storage of the device, and when a motion of the hand 404 is photographed by the camera and received as an image, the controller of the device may detect the hand shape of the user in the received image.

In operation S630, the controller of the device may analyze the detected hand region. The controller may analyze the detected hand region by performing image segmentation on the detected hand region. The controller may analyze the detected hand region by performing image segmentation on at least one of the obtained images. The controller may determine a boundary of the detected hand region in the obtained images, based on changes of a pixel value in the boundary of the hand region. According to an exemplary embodiment, depth values may be received by the device, and the detected hand region may be distinguished from other regions based on received depth values.

In operation S640, the controller of the device may extract the hand shape in the obtained images. The detected hand region is analyzed in operation S620 so that the controller may determine the hand shape in the obtained images based on analysis result of operation of S630 which results in determination of a boundary of the detected hand region in the obtained images. The controller may extract the hand shape to determine a movement of the hand shape as a reference for motion determination.

In operation S650, the device may determine which motion the movement of the hand shape corresponds to. For example, the device may determine whether the movement of the hand shape is a left-right swipe motion or a right-left swipe motion. As described above, the device may measure geometrical information of the hand shape to determine which motion is made by the plurality of motion inputs.

An operation of detecting a hand region by using a charge-coupled device (CCD) camera as the input unit of the device will be described.

A method of detecting a hand region by using a CCD color image may be performed using color information and geometrical shape information. A hand region detecting method based on color information in a red-green-blue (RGB) color space may be sensitive to a change in illumination. A hand region may be detected by a YCbCr color space or a YIQ color space converted from the RGB color space.

The YCbCr color space is a type of color space applied to an image system and expressed by a color expression method where a brightness component and a color difference component are separated from color information. Here, Y may denote a luminance signal, and Cb and Cr may denote color difference signals.

Cb and Cr are used in the YCbCr color space for reducing influences of various illumination changes, and thus, the device may binarize a hand region. The binarized hand region may be used for motion recognition by using a secondary moment shape characteristic value.

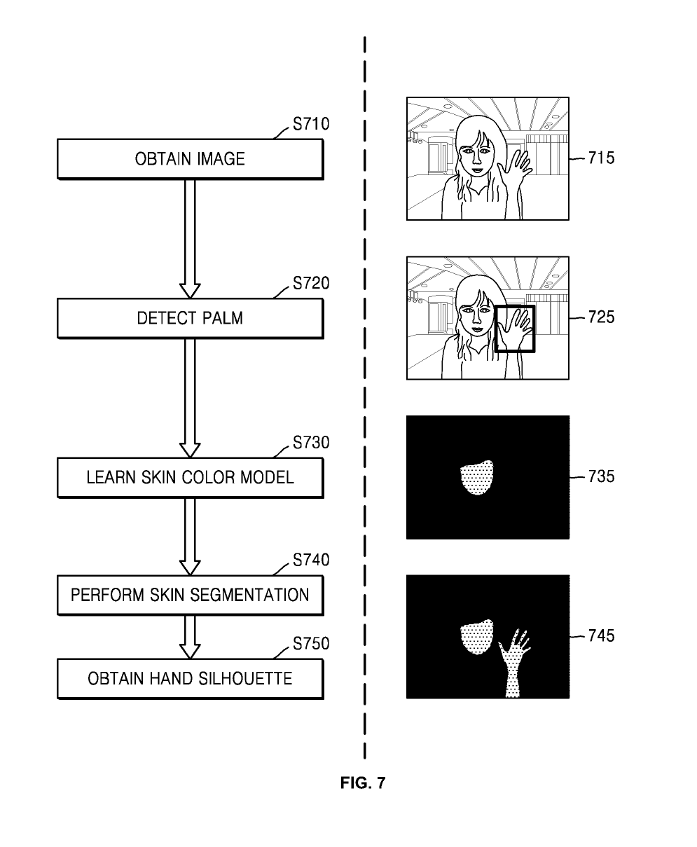

FIG. 7 is a flowchart illustrating a step of detecting a hand region of a user, according to another exemplary embodiment.

In operation S710, the device may obtain images through the input unit. The controller of the device may determine a signal processing (such as digital signal processing (DSP)) target among the obtained images. As illustrated on the right of FIG. 7, the device may determine the obtained image 715 as the signal processing target. Images 715, 725, 735,and 745 are illustrated differently each other, but may be derived from one image.

In operation S720, the controller of the device may detect a palm region in the image 715. The storage of the device may store shape information corresponding to the palm region. The storage may store various subject shapes such as a face shape, an arm shape, a leg shape, a foot shape, and/or the like, in addition to the palm region. The controller of the device may detect the palm region in an image 725. Images 715 and 725 may be the same image.

In operation S730, the controller of the device may perform skin color model learning. By performing skin color model learning, the controller may obtain skin color of the detected palm region. The palm has a skin color and color information of pixels corresponding to the palm may be different from other pixels in the image. The controller may perform gray scale processing on the palm region detected in the image and the palm region may be distinguished from other regions in a gray scale processed image by white and black instead of a color difference.

A face region may have pixel information similar to pixel information of the palm region since they have the same or similar skin color. The controller of the device may search the database stored in the storage to distinguish a shape of the face region and a shape of the palm region from other regions in the image. The shape of the face region and the shape of the palm region may be distinguished by using a whole shape of detected subjects as another distinguishing reference.

In operation S740, the controller of the device may determine the palm shape in the palm region. Therefore, the controller of the device may obtain movement information of the palm shape or palm region.

In operation S750, the controller of the device may obtain silhouette or contour information of the palm shape to receive a motion input of the palm.

Hereinabove, an example of determining a motion of a user in an image which is obtained by using the optical image sensor, such as the camera or the like, is described. However, the input unit of the device may be embodied by various types of sensors, and a subject region may be detected by an infrared camera. Hereinafter, a step of detecting a face candidate region by using the infrared camera will be described.

Since a subject emits infrared energy based on a temperature of the subject itself, the infrared camera of the device may detect energy of an infrared region emitted from a moving subject. A surface temperature of an object may be shown by a temperature distribution information image of the object. Therefore, a face region may be detected by using a temperature distribution of the face region in an infrared image. Firstly, the controller of the device may first obtain an infrared image.

Subsequently, the controller of the device may detect a primary face candidate region based on a temperature distribution in the infrared image and binarize the detected primary face candidate region.

Subsequently, the controller of the device may perform morphological filtering and geometrical correction on the binarized primary face candidate region.

Subsequently, the controller of the device may perform Blob Labeling image processing.

Subsequently, the controller of the device may determine whether a portion detected as the face candidate region is a face region, based on a secondary moment shape characteristic value.

Subsequently, the controller may determine the portion as the face region.

According to an exemplary embodiment, the device may detect a face region based on temperature distribution set within a certain range.

The detection method with reference to FIG. 6 and the infrared detection method may be employed in a combination thereof, thereby an accuracy of detection of a subject may be enhanced.

### Embodiment 1: Swipe

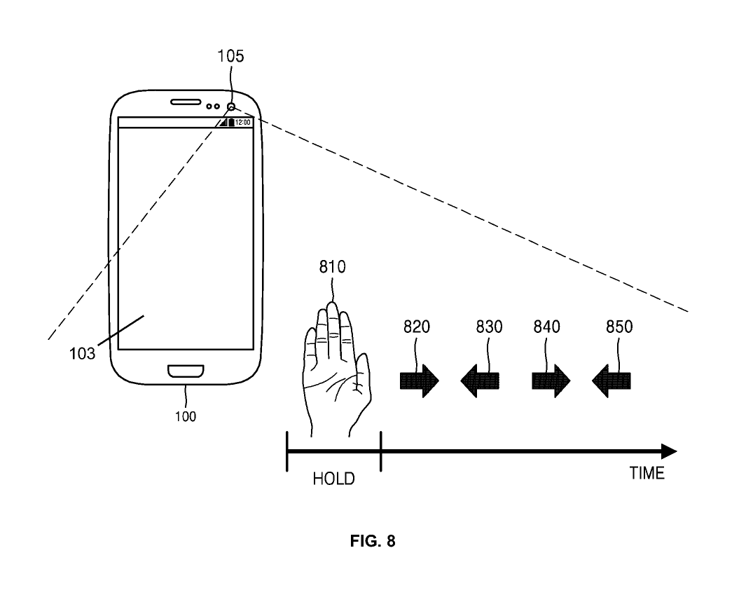

FIG. 8 is a diagram illustrating a method of recognizing a swipe motion input, according to an exemplary embodiment.

A user may execute an application of the device 100 and may input a control command to the device 100 for operating the application. For example, a left-right swipe input or a right-left swipe input may be input to a tablet personal computer (PC) in order for the user to view a plurality of images through an image viewer application of the tablet PC.

The user may physically input a swipe input to the device 100. The user may input the swipe input through a touch screen of the device 100, or may input the swipe input through a touch pad. Alternatively, the user may input the swipe input through a hard key or a joystick.

However, a case where the user directly and physically inputs the control command to the device 100 causes inconvenience to the user. In this case, the user may transmit the control command to the device 100 by using a remote controller, but a case incapable of using the remote controller may occur.

For example, a user may be cooking. In this case, the user may cook while looking at a recipe displayed by a tablet PC and may input a swipe input for switching to a next screen displaying the recipe. In this case, the hand 404 and/or a foot of the user may be smeared with food and/or drink, and for this reason, the user cannot directly manipulate the tablet PC or cannot use the remote controller. Instead, a swipe command may be input to the tablet PC by inputting a voice command of the user, or when the user is cooking, sounds of ambient cooking utensils may act as noise against the voice command, and for this reason, a device cannot normally recognize the voice command. Therefore, when the user makes a certain motion input in front of a device such as a tablet PC or the like, this may be the most intuitive and efficient control command input.

When the user makes successive swipe motion inputs in front of a front camera 105 of the device 100, the front camera 105 may photograph the user making motion inputs. As illustrated in FIG. 8, in a time section 810, the user may hold his hand 404 for or more than a predetermined time.

The input unit such as the front camera 105 of the device 100 may capture successive images including the hand 404 of the user, and the controller of the device 100 may detect a hand region in the captured images. The controller may recognize a movement (a motion) of the hand 404 detected in the successive images.

When a movement of the hand 404 of the user is made within a predetermined margin of error in the time section 810, the controller may determine a motion input received in a time section 820, as an intended motion input matched with an intention of the user.

In a time section 820, the user may make a left-right swipe motion input as shown in FIG. 8. The detected hand region moves from the left to the right through the successive images. The controller may determine the left-right swipe motion input as an intended motion input.

The controller of the device 100 may search the database of the storage to recognize a device control command corresponding to the left-right swipe motion. The left-right swipe motion may correspond to a control command which calls a left screen (or previous screen) for the image viewer application. Therefore, the controller may control the display to display a left screen of a current displayed screen.

In a time section 830, the user may move the hand 404 from the right to the left for repeating the left-right swipe motion. In this case, a movement of the hand 404 of the user may be photographed by the input unit such as the front camera 105.

The controller of the device 100 may determine whether the determined right-left swipe motion is matched with an intended motion input of the user. When the controller determines the left-right swipe motion as the intended motion input in the time section 820 after the time section 810 where a stationary state is maintained for or more than a predetermined time, the controller may determine the right-left swipe motion, which is made in the time section 830, as unintended motion input of the user. Therefore, the controller may not perform any control operation for the unintended motion input.

Moreover, the controller of the device 100 may control the display of the device 100 to display that a motion input, which is input after the intended motion input and is the unintended motion input, is an abnormal input. Alternatively, the display may display which motion is recognized by the intended motion input of the user. The user may check whether the recognized motion displayed in the display is matched with his intention.

In a time section 840, the user may input the left-right swipe motion in line of sight of the device 100, and the controller may determine the left-right swipe motion as the intended motion input and may call a left screen of a current displayed screen.

Subsequently, in a time section 850, when the user moves the hand 404 in the left direction for returning the hand 404 to an original position, the controller may determine the movement as the right-left swipe motion. Also, the controller may determine the determined right-left motion input as an unintended motion input and may not perform any control operation.

### Embodiment 2: Pinch-to-Zoom

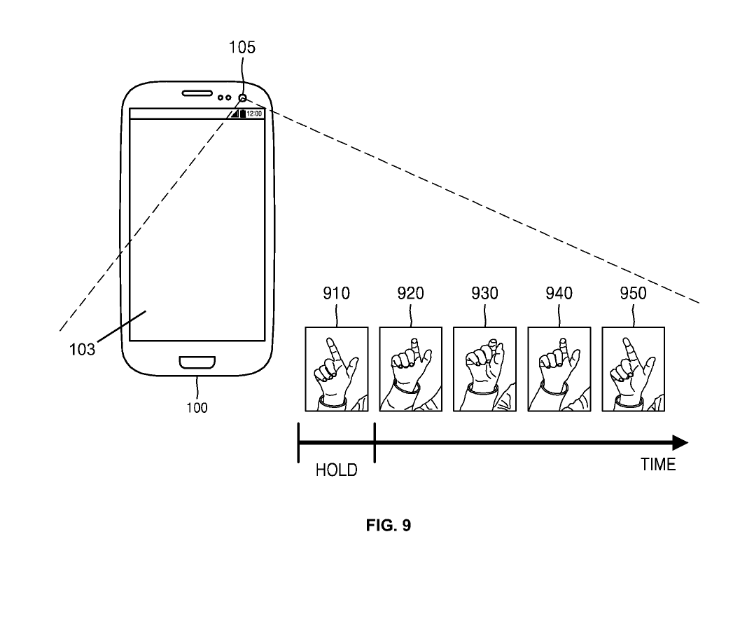

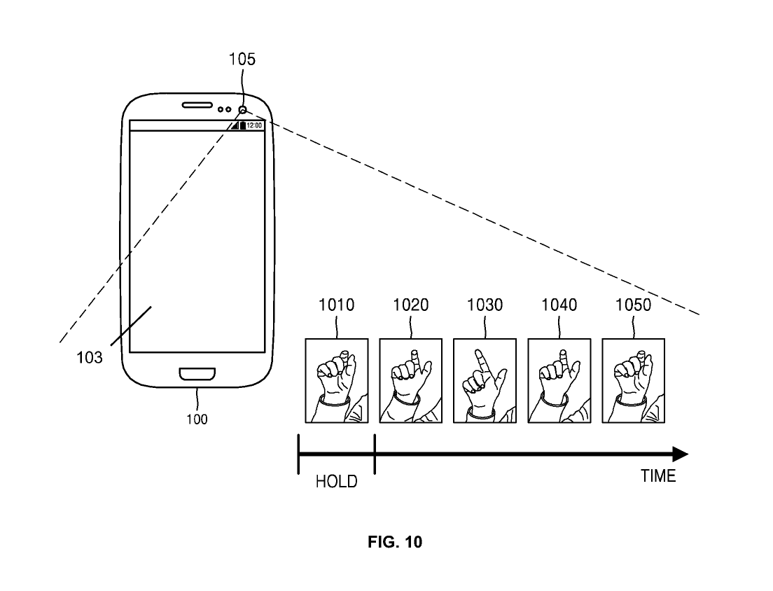

FIGS. 9 and 10 are diagrams illustrating a method of recognizing a pinch-to-zoom motion input, according to an exemplary embodiment.

A user may execute an application of the device and may input a control command to the device for operating the application. For example, the user may input a pinch-to-zoom input to the device, for zooming-in or zooming-out an image in the image viewer application of a tablet PC.

The user may make successive pinch-to-zoom motion inputs toward the front camera 105 of the device 100. As illustrated in FIG. 9, the user may hold in front of the front camera 105 for or more than a predetermined time in a time section 910.

The input unit such as the front camera 105 of the device 100 may capture successive images including the hand 404 of the user and may detect a hand region in the captured image. The controller may recognize a movement (a motion) by the hand region detected in successive images. Particularly, a silhouette of the whole hand region may be determined based on the thumb and the index finger, and the controller may recognize movements of the thumb and the index finger.

Since a movement of the hand 404 of the user is made within a predetermined margin of error in the time section 910, the controller may determine a motion input which is input in a time section 920, as an intended motion input matched with an intention of the user.

In time sections 920 and 930, the user may make a pinch-to-zoom motion input for zoom-out, by reducing a distance between the thumb and the index finger. Since the distance between the thumb and the index finger detected in the successive images is reduced, the controller may determine an intended motion input of the user as a zoom-out pinch-to-zoom motion.

The controller of the device 100 may search the database of the storage to recognize a device control command corresponding to the zoom-out pinch-to-zoom motion. The zoom-out pinch-to-zoom motion may correspond to a control command which zoom-out a screen in the image viewer application. Therefore, the controller may perform control to zoom-out a screen which is currently displayed by the display.

In time sections 940 and 950, the user may increase the distance between the thumb and the index finger for inputting the zoom-out pinch-to-zoom motion again. In this case, a movement of the hand 404 of the user may be photographed by the input unit of the device 100, and the controller of the device 100 may obtain zoom-in pinch-to-zoom motion, based on the photographed movement.

The controller of the device 100 may determine whether the determined zoom-in pinch-to-zoom motion is matched with an intended motion input of the user. When the controller determines the zoom-out pinch-to-zoom motion as the intended motion input in the time sections 920 and 930 after the time section 910 where a stationary state is maintained for or more than a predetermined time, the controller may determine the zoom-out pinch-to-zoom motion, which is made in the time sections 940 and 950, as an unintended motion input of the user. Therefore, the controller may not perform any control operation for motion inputs in the time sections 940 and 950.

Moreover, the controller of the device 100 may control the display of the device 100 to display that a motion input, which is input after the intended motion input and is the unintended motion input, is an abnormal input. Alternatively, the display may display which motion is recognized by the intended motion input of the user is. The user may check whether the recognized motion displayed in the display is matched with his intention

After the time section 950, the user may make the zoom-out pinch-to-zoom motion for zooming further out a current displayed image. Since the intended motion input of the user is determined as the zoom-out pinch-to-zoom motion, although the zoom-out pinch-to-zoom motion is immediately input to the device 100 without holding for or more than the predetermined time, the zoom-out pinch-to-zoom motion may be determined as an intended motion input, and thus, the device 100 may perform control to zoom-out the current displayed image.

Unlike FIG. 9, FIG. 10 is a diagram illustrating a case where an intended motion input is a zoom-in pinch-to-zoom motion. An operation illustrated in FIG. 10 may be described with the same principle as the principle described above with reference to FIG. 9.

Since a movement of the hand 404 of a user is made within a predetermined margin of error in a time section 1010, the controller of the device 100 may determine a motion input of the user, which is input in a time section 1020, as an intended motion input matched with an intention of the user.

In time sections 1020 and 1030, the user may make a zoom-in pinch-to-zoom motion input, which is made by increasing a distance between a thumb and an index finger. Since the distance between the thumb and the index finger detected in the successive images increases, the controller may determine an intended motion input of the user as a zoom-in pinch-to-zoom motion.

The controller of the device 100 may search the database of the storage to recognize a device control command corresponding to the zoom-in pinch-to-zoom motion. The zoom-in pinch-to-zoom motion may correspond to a control command which zooms in a screen for an image viewer application which is currently executed. Therefore, the controller may perform control to zoom-in a screen which is currently displayed by the display.

In time sections 1040 and 1050, the user may increase the distance between the thumb and the index finger for inputting the zoom-in pinch-to-zoom motion to the device 100 again. In this case, a movement of the hand 404 of the user may be photographed by the input unit of the device 100, and the controller of the device 100 may detect a zoom-in pinch-to-zoom motion, based on the photographed movement.

The controller of the device 100 may determine whether the determined zoom-in pinch-to-zoom motion is matched with an intended motion input of the user. Since the controller determines the zoom-in pinch-to-zoom motion as the intended motion input in the time sections 1020 and 1030 after the time section 1010 where a stationary state is maintained for or more than a predetermined time, the controller may determine the zoom-in pinch-to-zoom motion, which is made in the time sections 1040 and 1050, as an unintended motion input of the user. Therefore, the controller may not perform any control operation for motion inputs in time sections 1240 and 1050.

Moreover, the controller of the device 100 may control the display of the device 100 to display that a motion input, which is input after the intended motion input and is the unintended motion input, is an abnormal input. Alternatively, the display may display which motion is determined as the intended motion input of the user. The user may check whether the displayed motion input is matched with an intention of the user.

After the time section 1050, the user may make the zoom-in pinch-to-zoom motion for zooming further in an image displayed by the device 100. Since the intended motion input of the user has been determined as the zoom-in pinch-to-zoom motion, although the zoom-in pinch-to-zoom motion is immediately input to the device 100 without holding for or more than the predetermined time, the zoom-in pinch-to-zoom motion may be recognized as the intended motion input, and thus, the device 100 may perform control to zoom-in an image displayed on a screen.

### Embodiment 3: Rotation

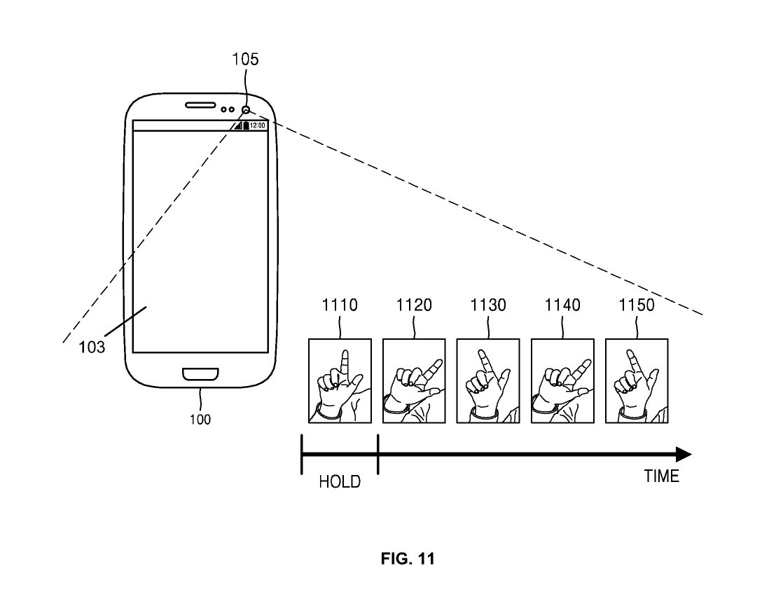

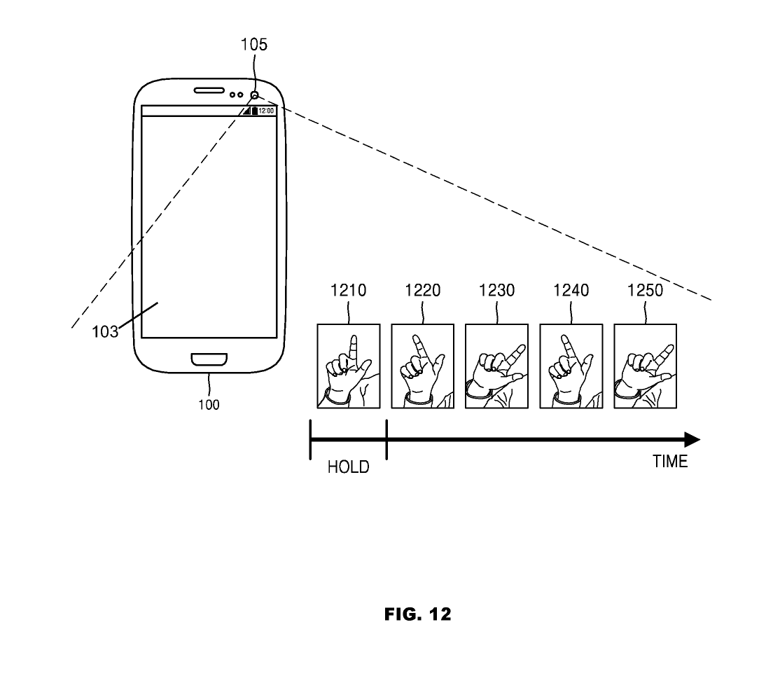

FIGS. 11 and 12 are diagrams illustrating a method of recognizing a rotation motion input, according to an exemplary embodiment.

A user may execute an application of the device and may input a control command to the device for operating the application which is executed. For example, the user may input a rotation input to the device, for rotating an image displayed in the image viewer application or a displayed screen.

The user may make successive rotation motion inputs toward the front camera 105 of the device 100. As illustrated in FIG. 11, the user may hold his hand 404 in front of the front camera 105 for or more than a predetermined time in a time section 1110.

The input unit of the device 100 may capture successive images including the hand 404 of the user and may detect a hand region in the captured images. The controller may recognize a movement (a motion) by the hand region detected in successive images. Particularly, since the thumb and the index finger determine a silhouette of the whole hand region, the controller may recognize movements of the thumb and the index finger.

Since a movement of the hand 404 of the user is made within a predetermined margin of error in the time section 1110, the controller may determine a motion input of the user, which is input in a next time section, as an intended motion input matched with an intention of the user.

In a time section 1120, the user may make a clockwise rotation motion input, which is made by clockwise rotating the thumb and the index finger. Since positions of the thumb and the index finger detected in the successive images are clockwise rotated, the controller may determine an intended motion input of the user as a clockwise rotation motion.

The controller of the device 100 may search the database of the storage to recognize a device control command corresponding to the clockwise rotation motion. The clockwise rotation motion may correspond to a control command which clockwise rotates an image or a screen. Therefore, the controller may perform control to clockwise rotate an image or a screen which is currently displayed by the display. In this case, a degree of rotation may be determined according to a size of an angle of rotation of the thumb and the index finger.

In a time section 1130, the user may counterclockwise rotate the thumb and the index finger for inputting the clockwise rotation motion to the device 100 again. In this case, a movement of the hand 404 of the user may be photographed by the input unit of the device 100, and the controller of the device 100 may determine the user as making a counterclockwise rotation motion, based on the photographed movement.

The controller of the device 100 may determine whether the determined counterclockwise rotation motion is matched with an intended motion input of the user. Since the controller determines the clockwise rotation motion as the intended motion input in the time section 1120 after the time section 1110 where a stationary state is maintained for or more than a predetermined time, the controller may determine the counterclockwise rotation motion, which is made in the time section 1130, as an unintended motion input of the user. Therefore, the controller may not perform any control operation for motion inputs in time sections 1130.

Moreover, the controller of the device 100 may control the display of the device 100 to display that a motion input, which is input after the intended motion input and is the unintended motion input, is an abnormal input. Alternatively, the display may display which motion is recognized by the intended motion input of the user. The user may check whether the displayed motion is matched with an intention of the user.

In a time section 1140, the user may make the clockwise rotation motion for further rotating an image which is displayed by the device 100. Since the intended motion input of the user has been determined as the clockwise rotation motion, although the clockwise rotation motion is immediately input to the device 100 without holding his hand 404 for or more than a predetermined time, the clockwise rotation motion may be recognized as the intended motion input, and thus, the device 100 may perform control to clockwise rotate an image which is displayed on a screen.

Unlike the above-described intended motion input of FIG. 11, which is a clockwise rotation motion, FIG. 12 is a diagram illustrating a case where an intended motion input is a counterclockwise rotation motion. An operation illustrated in FIG. 12 may be described with the same principle as the principle described above with reference to FIG. 11.

Since a movement of the hand 404 of a user is made within a predetermined margin of error in a time section 1210, the controller of the device 100 may determine a motion input of the user, which is input in a next time section, as an intended motion input matched with an intention of the user.

In a time section 1220, the user may make a counterclockwise rotation motion input, which is made by counterclockwise rotating a thumb and an index finger. Since the thumb and the index finger detected in the successive images are counterclockwise rotated, the controller may determine an intended motion input of the user as a counterclockwise rotation motion.

The controller of the device 100 may search the database of the storage to recognize a device control command corresponding to the counterclockwise rotation motion. The counterclockwise rotation motion may correspond to a control command which counterclockwise rotates an image or a screen. Therefore, the controller may perform control to counterclockwise rotate an image or a screen.

In a time section 1230, the user may clockwise rotate the thumb and the index finger for inputting the counterclockwise rotation motion to the device 100 again. In this case, a movement of the hand 404 of the user may be photographed by the input unit of the device 100, and the controller of the device 100 may determine the user as making a clockwise rotation motion, based on the photographed movement.

The controller of the device 100 may determine whether the determined clockwise rotation motion is matched with an intended motion input of the user. Since the controller determines the counterclockwise rotation motion as the intended motion input in the time section 1220 after the time section 1210 where a stationary state is maintained for or more than a predetermined time, the controller may determine the clockwise rotation motion, which is made in the time section 1230, as an unintended motion input of the user. Therefore, the controller may not perform any control operation.

Moreover, the controller of the device 100 may control the display of the device 100 to display that a motion input, which is input after the intended motion input and is an unintended motion input, is an abnormal input. Alternatively, the display may display which motion is recognized by the intended motion input of the user. The user may check whether the displayed motion is matched with his intention.

In a time section 1240, the user may make the counterclockwise rotation motion for further counterclockwise rotating an image which is displayed by the device 100. Since the intended motion input of the user is determined as the counterclockwise rotation motion, although the counterclockwise rotation motion is immediately input to the device 100 without holding for or more than a predetermined time, the counterclockwise rotation motion in the time section 1240 may be determined as the intended motion input, and thus, the device 100 may perform control to counterclockwise rotate an image or a screen which is displayed.

### Embodiment 4: Depth Motion

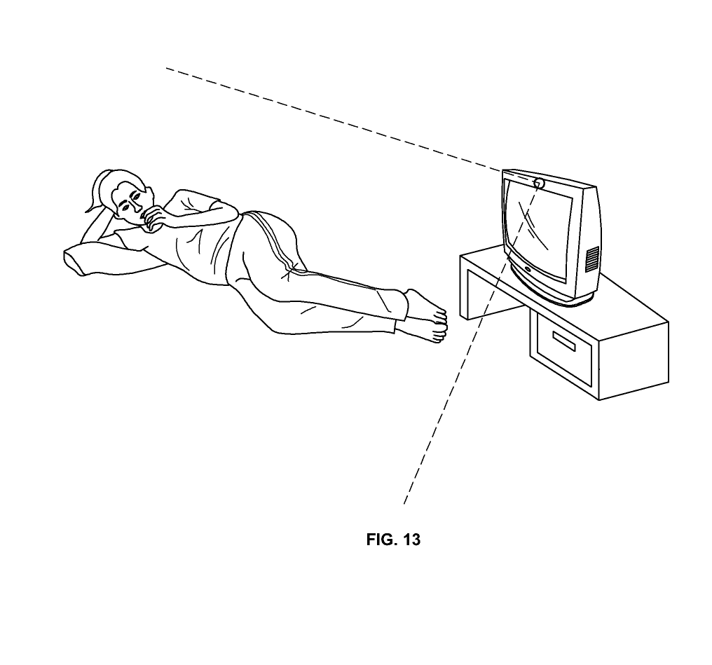

FIG. 13 is a diagram illustrating a method of recognizing a motion using a body of a user, according to an exemplary embodiment.

The motions described above with reference to FIGS. 8 to 12 may be motions of a user in a space which is spaced apart from the device by a certain distance. Hereinafter, in an exemplary embodiment, a motion input which is made by a distance (a depth) between a subject and the device will be described.

A user may make various types of motions at various positions. The device may receive a motion input of the user and may match the received motion input with a control command stored in the storage to perform a control operation.

As illustrated in FIG. 13, a user may input a control command with feet in front of a device such as a television (TV) or the like. When the user's foot gets closer to the TV, the TV may turn down the volume of video, and when the foot gets farther away from the TV, the TV may turn up the volume, according to an exemplary embodiment.

When the user makes a stationary motion for or more than a predetermined time for turning down the volume and then moves the foot closer to the TV, the TV may detect a foot region of the user to determine whether the feet get closer to the TV, and may determine a corresponding motion as an intended motion input matched with an intention of the user to turn down the volume.

After the volume is turned down, the user's feet may return to an original position. The feet gets farther away from the TV, but the TV may determine a corresponding motion as an unintended motion input of the user, since the stationary motion for the predetermined time is not followed by the corresponding motion. Therefore, a reverse motion accompanied with a motion input of a user may be ignored.

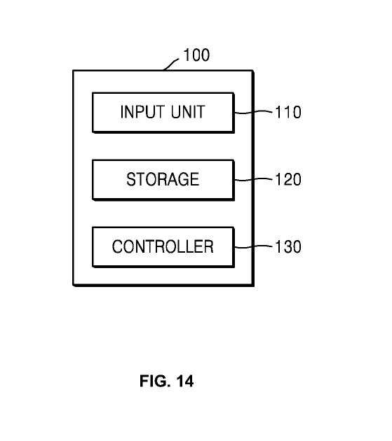

FIG. 14 is a block diagram conceptually illustrating a structure of a device 100 according to an exemplary embodiment.

The device 100 according to an exemplary embodiment may include an input unit 110,a storage 120, and a controller 130.

The input unit 110 according to an exemplary embodiment may receive a motion input of a user. The input unit 110 may convert the motion input of the user, sensed by a sensor which is built in the device 100 or is connected to the device 100 by wire or wirelessly, into the form of an image, video, or voice.

The input unit 110 may receive a plurality of motions as well as a one-time motion of the user. The input unit 110 may obtain a continuous movement of the user as movement information based on successive images.

The storage 120 according to an exemplary embodiment may store a motion of a user and a control command for the device 100, both of which may correspond to each other. The storage 120 may store a database of various motion inputs set by the user, based on various references. For example, a left-right swipe motion input may correspond to different control commands based on executed applications. For example, the left-right swipe motion input may correspond to a control command that calls a left screen of a screen which is displayed in an image viewer, and to a control command that turns up the volume in a music player.

According to an exemplary embodiment, a control command may be determined based on what subjects performs motions. A rotation motion by the hand 404 and a rotation motion by a foot may correspond to different control commands.

A motion input of the user and a control command may correspond to each other according to various references, and information about their relationship may be stored in the storage 120. A control command may be determined based on positions or places at which a motion is made, or various pieces of context information of an environment where the user is located. The context information may include illuminance, a temperature, humidity, a noise level, and/or the like.

The controller 130 according to an exemplary embodiment may detect a subject, which is a main agent of a motion, in a motion input of the user

The controller 130 may determine an intended motion input matched with an intention of the user. The controller 130 may determine, as the intended motion input, an initial motion input which is input by the user right after a stationary state is maintained for or more than a predetermined time. Therefore, the controller 130 may perform control command corresponding to the intended motion input among various motion inputs.

The controller 130 may re-determine an intended motion input of the user when a motion which differs from a previous intended motion input is input after a stationary state is maintained for or more than a predetermined time. The controller 130 may determine the input motion as a newly intended motion input and may perform only control corresponding to the newly intended motion input.

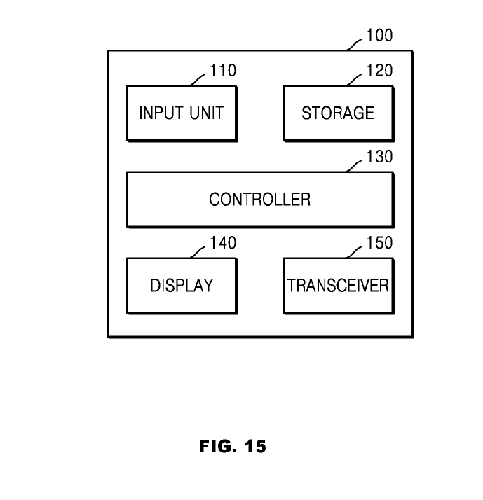

FIG. 15 is a block diagram conceptually illustrating a structure of a device 100 according to another exemplary embodiment.

The device 100 according to another exemplary embodiment may include an input unit 110, a storage 120, and a controller 130. Also, the device 100 may further include a display 140 and a transceiver 150.

The input unit 110, the storage 120, and the controller 130 have been described above with reference to FIG. 14. Hereinafter, therefore, the display 140 and the transceiver 150 will be intensively described.

The display 140 according to an exemplary embodiment may display a screen for an application which is executed by the device 100. Depending on the case, like a touch screen, the display 140 may simultaneously perform an input operation and a display operation.

The display 140 may display an obtained motion image of a user when a motion of the user is input. The display 140 may display an image obtained through the input unit 110 as-is, or may display another type of image stored in the storage 120. For example, the display 140 may display a motion input of the user, which is received through a front camera of a smartphone, in a picture-in-picture form. Alternatively, when a motion input of the user is a left-right swipe motion input, the display 140 may display a right arrow image stored in the storage 120.

The transceiver 150 according to an exemplary embodiment may perform communicate between the device 100 and an external device. The transceiver 150 may communicate with a remote controller of the device 100, or may transmit or receive a control command to or from another device.

For example, when the user inputs an zoom-in pinch-to-zoom motion through a front camera of a smartphone, the transceiver 150 of the smartphone may transmit, to a TV which is an external device, image information corresponding to the zoom-in pinch-to-zoom motion or information about where the zoom-in pinch-to-zoom motion is a control command for enlarging an image, thereby enlarging the image which is displayed by the TV.

In digital devices that perform various functions, a user environment (UI/UX) is an important issue. For example, since conventional televisions (TVs) are replaced with smart TVs, that a user conveniently uses various functions provided by a smart TV is one of important issues when the smart TV is located in a living room of a general home. Smart TVs may provide various pieces of Internet-based content, which is provided by general PCs, such as Internet web surfing, e-mail, games, photographs, music, video media, and/or the like, in addition to broadcast content. However, when a user feels uncomfortable because various pieces of content are provided, the utility of smart TVs is reduced. Therefore, a GUI providing apparatus and method according to the exemplary embodiments may be applied to multimedia apparatuses such as smart TVs and/or the like, and thus, a user's convenience is enhanced.

The inventive concept may also be embodied as processor readable codes on a processor readable recording medium included in a digital device such as a central processing unit (CPU). The computer readable recording medium is any data storage device that may store data which may be thereafter read by a computer system. Examples of the computer-readable recording medium include read-only memory (ROM), random-access memory (RAM), compact disc (CD)-ROMs, magnetic tapes, floppy disks, and optical data storage devices. The computer readable recording medium may also be distributed over network coupled computer systems so that the computer readable code may be stored and executed in a distributed fashion. Also, functional programs, codes, and code segments for implementing the method of providing a graphical user interface (GUI) may be easily construed by programmers of ordinary skill in the art to which the inventive concept pertains.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of recognizing a motion of a user, the method comprising:
receiving, by a terminal, a plurality of motion inputs;
determining an intended motion input from among the plurality of motion inputs received; and
performing terminal control corresponding to the intended motion input determined from among the plurality of motion inputs received,
wherein determining an intended motion input comprises determining, as the intended motion input, a motion input which is input for a first time after a motion input which is in a stationary state for at least a predetermined time is received.

2. The method of claim 1, further comprising: storing the intended motion input determined in a storage of the terminal.

3. The method of claim 2, wherein the storage stores terminal control information corresponding to the intended motion input.

4. The method of claim 1, wherein the plurality of motion inputs are received via a movement of a predetermined subject shape among subject shapes which are input through an input unit of the terminal.

5. The method of claim 4, wherein the predetermined subject shape comprises at least one of shapes of a head, a hand, an arm, a foot, and a leg of the user.

6. The method of claim 1, wherein the plurality of motion inputs received comprise the intended motion input determined and a reverse motion input opposite to the intended motion input determined.

7. The method of claim 1, wherein the plurality of motion inputs received comprise at least one of a swipe motion input, a pinch-to-zoom motion input, and a rotation motion input.

8. The method of claim 1, wherein receiving a plurality of motion inputs comprises:
detecting a subject in successive images received by the terminal;
distinguishing a region of the detected subject from other regions via image segmentation; and
extracting a subject shape in the region of the detected subject distinguished.

9. The method of claim 8, further comprising: storing the subject shape in a storage of the terminal.

10. The method of claim 1, wherein
the plurality of motion inputs are received by an input unit of the terminal, and
the input unit comprises at least one of an optical sensor, an infrared sensor, an electromagnetic sensor, an ultrasonic sensor, and a gyro sensor.

11. A terminal for recognizing a motion of a user, the terminal comprising:
an input unit configured to receive a plurality of motion inputs; and
a controller configured to determine an intended motion input from among the plurality of motion inputs received and perform terminal control corresponding to the intended motion input determined from among the plurality of motion inputs received,
wherein the controller determines, as the intended motion input, a motion input which is input for a first time after a motion input which is in a stationary state for at least a predetermined time is received.

12. The terminal of claim 11, further comprising: a storage configured to store the intended motion input determined.

13. The terminal of claim 12, wherein the storage stores terminal control information corresponding to the intended motion input.

14. The terminal of claim 11, wherein the plurality of motion inputs are received by a movement of a predetermined subject shape among subject shapes which are input through an input unit of the terminal.

15. The terminal of claim 14, wherein the predetermined subject shape comprises at least one of shapes of a head, a hand, an arm, a foot, and a leg of the user.

16. The terminal of claim 11, wherein the plurality of motion inputs received comprise the intended motion input determined and a reverse motion which is moved opposite to the intended motion input determined.

17. The terminal of claim 11, wherein the plurality of motion inputs received comprise at least one of a swipe motion input, a pinch-to-zoom motion input, and a rotation motion input.

18. The terminal of claim 12, wherein the controller detects a subject in successive images received by the terminal, distinguishing a region of the subject detected from other regions, and extracts a subject shape in the region of the subject detected distinguished.

19. The terminal of claim 18, wherein the storage stores the subject shape.

20. The terminal of claim 11, wherein the input unit comprises at least one of an optical sensor, an infrared sensor, an electromagnetic sensor, an ultrasonic sensor, and a gyro sensor.

21. One or more non-transitory computer-readable storage media having recorded thereon a program for executing the method of claim 1 in a computer.

22. One or more non-transitory computer-readable storage media comprising instructions that are operable when executed to:
receiving, by a terminal, a plurality of motion inputs;
determining an intended motion input from among the plurality of motion inputs received; and
performing terminal control corresponding to the intended motion input determined from among the plurality of motion inputs received,
wherein determining an intended motion input comprises determining, as the intended motion input, a motion input which is input for a first time after a motion input which is in a stationary state for at least a predetermined time is received.
